(19) United States
(12) Patent Application Publication
(10) Pub. No.: US 2014/0129319 A1
(43) Pub. Date: May 8, 2014

(54) SYSTEM, METHOD, AND NON-TRANSITORY COMPUTER-READABLE MEDIUM FOR SIMULATING AN ELECTRONIC MESSAGE CAMPAIGN

(71) Applicants: Adam Gillaspie, Indianapolis, IN (US); Robert Weis, Indianapolis, IN (US); John Maitz, Indianapolis, IN (US)

(72) Inventors: Adam Gillaspie, Indianapolis, IN (US); Robert Weis, Indianapolis, IN (US); John Maitz, Indianapolis, IN (US)

(73) Assignee: ExactTarget, Inc., Indianapolis, IN (US)

(21) Appl. No.: 14/054,198

(22) Filed: Oct. 15, 2013

Related U.S. Application Data
(60) Provisional application No. 61/713,026, filed on Oct. 12, 2012.

(51) Int. Cl. G06Q 30/02

(52) U.S. Cl. CPC G06Q 30/0242
USPC 705/14.41

(57) ABSTRACT

A computerized system, method, and non-transitory computer-readable medium for simulating an electronic message campaign is disclosed including establishing one or more simulated subscribers and storing an information associated with each of the one or more simulated subscribers in a database, wherein the information comprises a profile information for each of the one or more simulated subscribers, receiving one or more communications addressed to the one or more simulated subscribers, processing the one or more communications based upon the profile information for each of the one or more simulated subscribers to generate a campaign activity, and processing the campaign activity.

### PRIORITY

This application claims priority to and the benefit of U.S. Provisional Application No. 61/713,026, filed on Oct. 12, 2012 which is incorporated herein by reference.

### BACKGROUND

Communication service providers offer products that enable businesses to design, implement, and track the success of marketing campaigns through a multitude of communication channels. As consumers become more market and technologically savvy, communication service providers develop new feature-rich products that help improve the success of marketing campaigns implemented by their customers. An efficient and successful way to sell these products to businesses is to demo their success with other customers in real time. However, new products are developed and implemented so quickly that a communication service provider may not have a successful customer story to share with prospective businesses.

Today, communication service providers show presentations to their prospective customers that include wireframes and static examples of what a successful implementation of a product would look like. If a prospective customer has a question about a specific feature, the communication service provider is required to explain the feature in the abstract or, in the best case, bring up a specific slide that shows an example of the feature in question.

It would be advantageous if the communication service provider could demo all of the features of a product to a prospective business with real or like-real data in real time. Then, if a prospective business has a specific question about a feature within a product, the communication service provider can simply demo the feature in question.

In addition, the marketing industry is constantly changing and communication service providers try to develop and implement new products that fit a consumer or business need as quickly as possible in reaction to such changes. One issue with the development and quality assurance processes surrounding these new products is that it is difficult to truly test how the new products would work with real customer data.

Accordingly, there exists a need for a system, method, and non-transitory computer-readable medium for simulating an electronic message campaign to obtain expected tracking and reporting metrics.

### BRIEF DESCRIPTION OF THE DRAWINGS

FIG. 1 illustrates a flowchart for simulating an electronic messaging campaign according to at least one embodiment of the present disclosure.

FIG. 2 illustrates components of a system for simulating an electronic messaging campaign according to at least one embodiment of the present disclosure.

FIGS. 3-7 display an example of a graphical user interface generated from execution of a computer-readable program for simulation of an electronic messaging campaign according to at least one embodiment of the present disclosure.

### DESCRIPTION

In the present disclosure, a system, method, and non-transitory computer-readable medium for simulating an electronic message campaign is disclosed. The simulation involves interacting with electronic messages using simulated subscribers in order to provide a user (e.g., company or business) with realistic results of tracking and reporting metrics. Based upon this feedback, a user may alter the campaign so as to better target particular demographics. For example, if the feedback shows that the target demographic of simulated subscribers is not opening the messages sent to them, the company behind the campaign may decide it needs to alter the content of the message or take some other action to penetrate the target demographic. Alternatively, an electronic message marketing company may use the simulation to determine whether it can effectively scale up to a large message campaign (e.g., from one thousand emails to ten million emails).

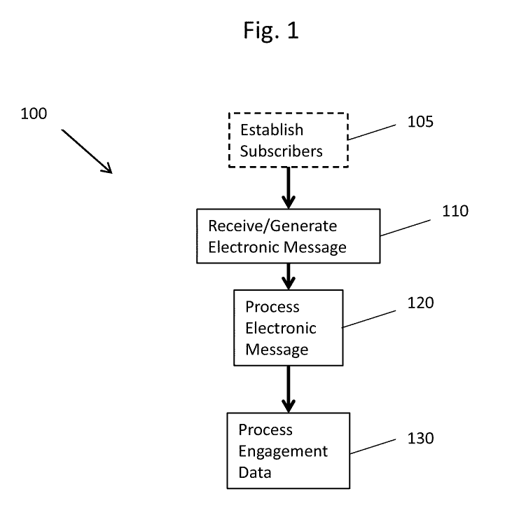

FIG. 1 shows a method 100 for simulating an electronic message campaign according to at least one embodiment of the present disclosure. As shown in FIG. 1, the method 100 may optionally include the step 105 of establishing simulated subscribers. The step 105 may include establishing vertical-specific benchmark data that defines the profile (e.g., demographic information) for each subscriber. Such data may include particular behavior attributes or metrics, such as levels of interests for particular goods and/or services (e.g., golf clubs and golfing). Such data may also include open rates, click rates, conversion rates, whether the simulated person is a loyalty member or follows the company on Twitter, number of times the person accesses email or other electronic messages, and the like. In at least one embodiment of the present disclosure, the subscribers may already be established. In at least one embodiment, the subscriber data may be created via an automated script using script logic. The profile information for the simulated subscribers may be stored using a variety of storage systems, including, but not limited to, a data structure server (e.g., a Redis key-value store). In such an embodiment, each virtual subscriber created during the step 105 may have one or more addresses associated with the virtual subscriber for the delivery of communications. For example, a virtual subscriber may have an email address, Twitter handle, Facebook profile name, LinkedIn account, and/or mobile number associated with the virtual subscriber. In the event that communications are later sent to a virtual subscriber and traffic is generated therefrom, the communications may be sent to one or more of the virtual subscriber's delivery address.

In at least one embodiment of the present disclosure, the establishment of simulated subscribers in step 105 may include defining a subscriber type and associating a subscriber type for each virtual subscriber. In such an embodiment, a subscriber type may include a pre-defined criteria as to how often a subscriber associated with the subscriber type may open a communication, click a link within a communication, reply to a communication, sign up to a mailing list, or otherwise interact with communications sent within marketing campaigns. In such an embodiment, a subscriber type may also include the type of device in which such subscribers may perform such activity. In such an embodiment, subscriber type may have different activity rates based on demographics or other criteria. Subscriber types may also include certain information about a subscriber associated with such a subscriber type, such as, for example, the number of Facebook friends, whether the subscriber has a Twitter handle, the age of the subscriber, etc. As used in the present disclosure, communication includes, but is not limited to, email, Facebook message, tweet, MMS, SMS, LinkedIn message, and other communication able to be received by a computing device.

For example, a subscriber type may be defined for a highly engaged subscriber. In this example, a highly engaged subscriber may open a communication between 60% and 70% of the time, click a link within a communication between 10% and 15% of the time, perform a conversion activity (e.g., sign up for a mailing list, purchase a product, etc.) resulting from a conversion 8% to 15% of the time. In this example, a highly engaged subscriber may have 90 to 1500 Facebook friends and have a Twitter handle.

In another example, a subscriber type may be defined for an unengaged subscriber. In this subscriber type, the unengaged subscriber may only open a communication 0% to 10% of the time, click a link within a communication 0% of the time, and perform a conversion activity 0% of the time. In this example, the unengaged subscriber type may not have a Facebook account or Twitter handle.

In at least one embodiment of the present disclosure, assigning a subscriber type to a set of virtual subscribers may automatically populate virtual demographic data for the virtual subscribers. In such an embodiment, the virtual demographic data may be defined within the subscriber type. For example, as previously discussed, a subscriber type for a highly engaged subscriber may automatically assign demographic data of the virtual subscriber having a Facebook account with 90 to 1500 friends. In another example, a subscriber type may include that any virtual subscriber assigned the subscriber type will have a certain percent chance to have one or more demographic information assigned to the virtual subscriber. For example, a highly engaged subscriber type may include that any virtual subscriber assigned to the highly engaged subscriber type will have a 45% chance of being male and a 55% chance of being male. In another example, any virtual subscriber assigned the highly engaged subscriber type may have a 1% chance of being born between 1928 and 1948, a 62% chance of being born between 1949 and 1986, and a 37% chance of being born between 1987 and 1999. It should be appreciated, then, that subscriber types may assign demographic information that assists in mimicking activity from a real-life set of subscribers with virtual subscribers by assigning defined subscriber types.

In at least one embodiment of the present disclosure, subscribers may be established in step 105 through scripting. In such an embodiment, an enterprise may define a set of subscriber types with accompanying information within a database. In such an embodiment, a script may populate a database table with a defined number of virtual subscribers and associate subscriber types to each virtual subscriber.

When simulating a marketing campaign by establishing subscribers in step 105, an enterprise may associate a number of virtual subscribers with these defined subscriber types such that activity performed by these virtual subscribers will conform to the metrics defined within the subscriber type. It should be appreciated that the use of subscriber types enables a simulation engine to more accurately depict real-life activity with various types of subscriber activity levels.

As shown in FIG. 1, the method 100 includes the step 110 of receiving or establishing one or more electronic messages and/or communications. In such an embodiment, electronic messages and/or communications may be delivered to virtual subscribers established in step 105. In such an embodiment, the delivery of communications to a virtual subscriber may include building and generating real communications to a locally hosted or remotely hosted infrastructure configured to receive communications for virtual subscribers. In an example where communications are built and delivered to virtual subscribers, a local or remote MTA may be configured to receive communications for virtual subscribers and thereafter placed into mailboxes for virtual subscribers. In another example where tweets or Twitter direct messages are sent to virtual subscribers, a local or remote infrastructure may be established to receive and house such messages for subsequent processing for each virtual subscriber. In this example, the tweets or Twitter direct messages may not be actual tweets or Twitter direct messages within Twitter's infrastructure and, instead, may be simulated communications that reside as content within a database or file server. It should be appreciated that a communication service provider or entity generating simulated communications through execution of the method 100 may generate communications that are delivered and stored within mock infrastructure configured for a simulation.

For example, emails and/or communications may be received from a remote email sender. In addition or alternatively, emails may be built by a remote email sender utilizing an application hosted locally, such as, for example, an application hosted by an electronic message marketing company and/or communication service provider that also hosts the simulation. In at least one embodiment, emails and/or communications may be established locally, such as, for example, by an electronic message marketing company that hosts the simulation. The emails may include various types of content for electronic message campaigns, including messages and designs, such as, for example, information about a sale for particular goods or services, an advertisement for coats showing a picture of an individual wearing a coat, and the like. In at least one embodiment, the emails are addressed to the subscribers. For example, each of a group of subscribers may have distinct email addresses for the same domain. For instance, one subscriber's email address may be jsmith@orange.com (“Jim”) and another subscriber's email address may be kford@orange.com (“Kelly”). While the simulation in this example is described referring to emails, it should be noted that any type of electronic message may be implemented. For example, the electronic message may be SMS, MMS, social media, and the like.

As shown in FIG. 1, the method 100 also includes the step 120 of processing the one or more electronic messages based upon the engagement profiles of the subscribers. For instance, after an email is accepted at the SMTP server of the host of the simulation, the processing step 120 may include the SMTP server looking at the address of the email and querying the subscriber (e.g., Jim or Kelly) in the database. After identifying the subscriber corresponding to the email (e.g., Jim or Kelly), the processing step 120 includes determining what actions the subscriber would take relative to the email based upon the engagement profile and/or subscriber type of the subscriber, including, but not limited to, whether the subscriber would open the email or take some other action.

In at least one embodiment, if it is determined that the subscriber would open the email, then the email may be converted into a form that can be easily parsed. For example, an HTML email may be converted into DOM scripting to allow for parsing of any element of the email. The parsing may begin with a web beacon (e.g., 1×1 tracking pixel image). By firing an HTTP GET request to the tracking pixel's source URL, an email “open” is simulated and recorded by the simulation. Of course, other actions may be performed to simulate an “open” if it is determined that a subscriber would open the email. The email may also be reviewed to determine whether the subscriber will take any other actions, such as, for example, click, purchase, complete a survey, unsubscribe, and the like. Based upon the likelihood of these other actions, there may be additional firings of HTTP GET requests to the source URL, which would also be recorded.

The step 120 determines whether an electronic message will be opened or some other activity will be taken in regards to the electronic message based upon the engagement profile of a subscriber. The engagement profile for a subscriber may be determined by considering a variety of factors and facts about the subscriber. For example, a subscriber may be highly engaged in electronic message campaigns of a company if the company has a Twitter Handle, if the subscriber follows the company on Twitter, if the subscriber “Likes” the company on Facebook, and the like. A subscriber between the ages of 13-30 may be highly engaged for social media, while a subscriber that is 65 years old or older may be unengaged for social media. The subscriber's engagement profile may also be determined based upon the type of electronic device or domain that the subscriber uses. For example, a user of an iPhone may be more engaged to electronic campaigns than an Android user, and a user of Outlook may be more engaged to electronic campaigns than a user of Gmail or Yahoo!. The subscriber's engagement profile may also be based on the type of acquisition source, such as social media, mobile, website, and the like.

For example, suppose simulated subscriber Abe's engagement profile shows that he has a high level of engagement for sports and the email being processed by the simulation includes a subject heading for baseball. Based upon the subject heading alone, it is likely that Abe would open up the email since Abe is highly engaged with such content. However, if the email information is related to knitting, it may be unlikely that Abe would open the email to look at the email because Abe's level of engagement for such content may be low. In the former case, an HTTP GET request would be generated to the source URL to indicate an “open” and be recorded by the simulation.

It should be noted that the processing step 120 may be fully automatic. That is, as electronic messages are received or otherwise obtained for processing, each may be processed automatically without user action. This would allow for uninterrupted, continuous processing of one or more electronic message campaigns. For example, if multiple companies each have several email campaigns for testing using the simulation, they can each send their emails in any order, at any time and receive feedback about each campaign. They would not have to wait for an administrator to perform any operations to carry out the simulation. Such activity by multiple companies would also be beneficial to an email marketing company that may operate the simulation because the marketing company can determine whether their systems can withstand the high volume of messaging from multiple sources.

It should also be noted that the selection of subscribers used to carry out the processing step 120 may be selected by the user, automatically selected based upon the company's own subscribers, or otherwise established based upon some rule or selection. With the ability to customize the subscriber lists for each simulation run, a company may be able to obtain targeted engagement results.

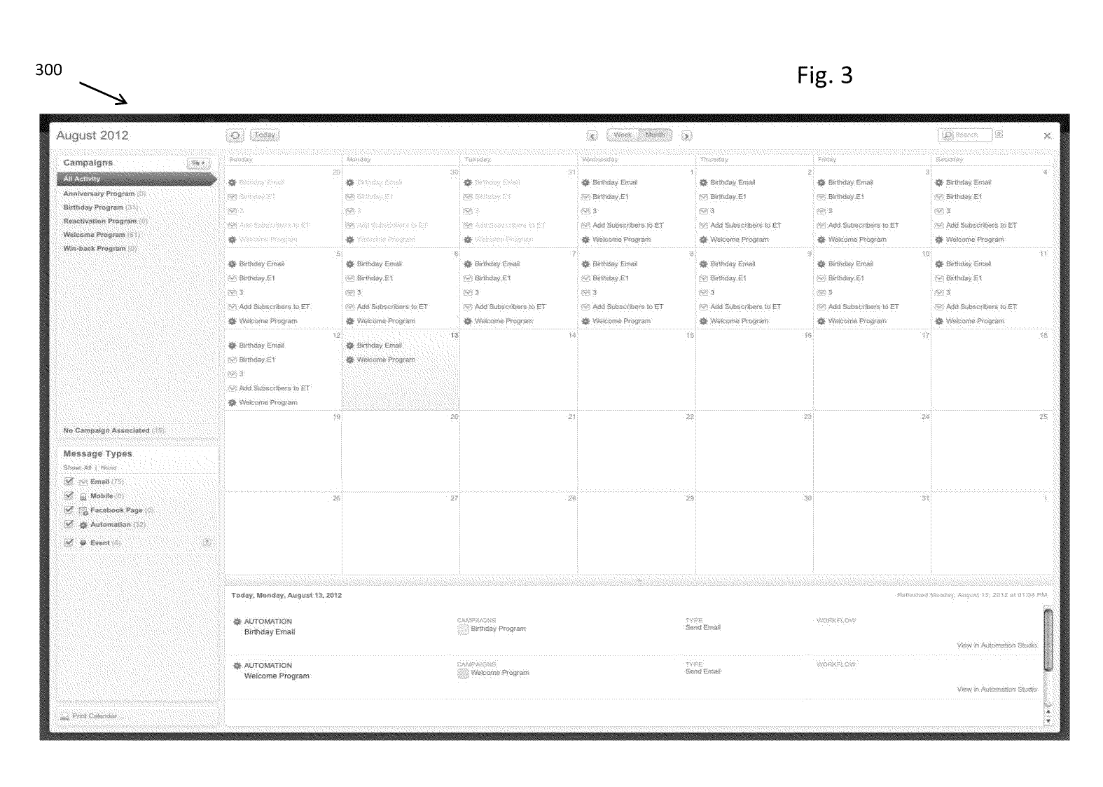

As shown in FIG. 1, the method 100 further includes the step 130 of processing engagement data produced by the simulated subscribers for campaigns. The step 130 may include adding up the number of virtual opens, clicks, purchases, surveys completed, unsubscribes, and other activity generated by virtual subscribers for one or more campaigns. As shown in FIGS. 3-7 (described below), the step 130 may include arranging and displaying engagement information in a manner that allows the user to understand what the expected metrics are for the campaign. The step 130 may also include performing an analysis of the data. For instance, the step 130 may include determining whether the proposed electronic message campaign penetrates particular demographics, such as seniors. In view of such results from the simulation, a company may alter, leave unchanged, or scrap the electronic message campaign. In view of the results of the simulation, the company may also decide to focus the campaign towards its subscribers that fit the identified demographic (e.g., seniors).

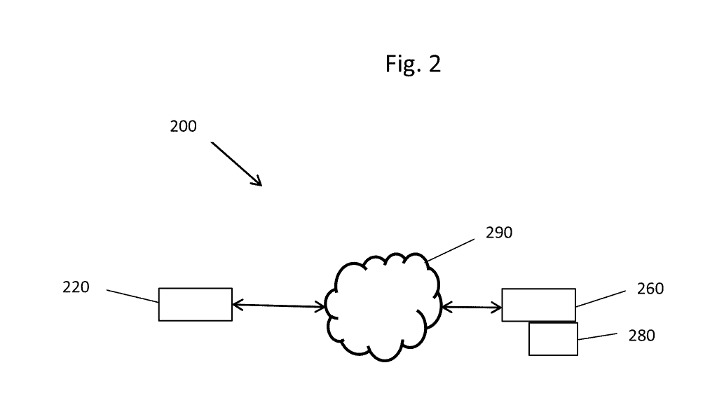

Referring now to FIG. 2, there is shown at least one embodiment of the components of the system for simulating an electronic message campaign 200 according to the present disclosure. System 200 comprises first remote device 220, host server 260, database 280, and computer network 290. For purposes of clarity, only one first remote device 220 is shown in FIG. 2. However, it is within the scope of the present disclosure that the system 200 may have two or more first remote devices 220 operating at the same time. In the embodiment shown in FIG. 2, first remote device 220 is operated by an e-mail sender. It should be noted that at least in one embodiment of the present disclosure, the first remote device 220 may not be remote from the other components of the system 200 but may be part of or locally connected to the host server 260 and the database 280.

The first remote device 220 may be configured to send electronic messages to the host server 260 via the computer network 290. In addition or alternatively, the first remote device 220 may be configured to access and utilize an application hosted on host server 260 to build one or more electronic messages. First remote device 220 includes one or more computers, computing devices, or systems of a type well known in the art, such as a mainframe computer, workstation, personal computer, laptop computer, hand-held computer, cellular telephone, or personal digital assistant. First remote device 220 comprises such software, hardware, and componentry as would occur to one of skill in the art, such as, for example, one or more microprocessors, memory systems, input/output devices, device controllers, and the like. First remote device 220 also comprises one or more data entry means (not shown in FIG. 2) operable by users of first remote device 220 for data entry, such as, for example, a pointing device (such as a mouse), keyboard, touchscreen, microphone, voice recognition, and/or other data entry means known in the art. First remote device 220 also comprises a display means (not shown in FIG. 2) which may comprise various types of known displays such as liquid crystal diode displays, light emitting diode display, and the like upon which information may be display in a manner perceptible to the user.

As described above, the host server 260 may be configured to receive electronic messages from the first remote device 220, host an application for the first remote device 220 to build electronic messages, and/or establish one or more electronic messages. In at least one embodiment, the host server 260 accesses the database 280 to obtain simulated subscriber information while processing the message in step 120. The host server 260 is configured to carry out one or more of the steps of method 100 described above. For example, the host server 260 may perform steps 110, 120, and 130 or steps 105, 110, 120, and 130. Host server 260 comprises one or more server computers, computing devices, or systems of a type known in the art. Host server 260 further comprises such software, hardware, and componentry as would occur to one of skill in the art, such as, for example, microprocessors, memory systems, input/output devices, device controllers, display systems, and the like. Host server 260 may comprise one of many well-known servers, such as, for example, IBM's AS/400 Server, IBM's AIX UNIX Server, or MICROSOFT's WINDOWS NT Server. In FIG. 2, host server 260 is shown and referred to herein as a single server. However, host server 260 may comprise a plurality of servers or other computing devices or systems interconnected by hardware and software systems know in the art which collectively are operable to perform the functions allocated to host server 260 in accordance with the present disclosure.

The database 280 is configured to store the simulated subscriber information and engagement information resulting from step 130 that is received from the host server 260. Database 280 is “associated with” host server 260. According to the present disclosure, database 280 can be “associated with” host server 260 where, as shown in the embodiment in FIG. 2, database 280 resides on host server 260. Database 280 can also be “associated with” host server 260 where database 280 resides on a server or computing device remote from host server 260, provided that the remote server or computing device is capable of bi-directional data transfer with host server 260. In at least one embodiment, the remote server or computing device upon which database 280 resides is electronically connected to host server 260 such that the remote server or computing device is capable of continuous bi-directional data transfer with host server 260.

For purposes of clarity, database 260 is shown in FIG. 1, and referred to herein as a single database. It will be appreciated by those of ordinary skill in the art that database 260 may comprise a plurality of databases connected by software systems of a type well known in the art, which collectively are operable to perform the functions delegated to database 260 according to the present disclosure. Database 260 may comprise a relational database architecture or other database architecture of a type known in the database art. Database 260 may comprise one of many well-known database management systems, such as, for example, MICROSOFT's SQL Server, MICROSOFT's ACCESS, or IBM's DB2 database management systems, or the database management systems available from ORACLE or SYBASE. Database 260 retrievably stores information or documents that is communicated to database 260 from first remote device 220 or through computer network 290.

First remote device 220 communicates with host server 260 via computer network 290. The communication between first remote device 220 and host server 260 may be bi-directional. Computer network 290 may comprise the Internet, but this is not required.

The following discussion relating to FIGS. 3-7 describes an example of a non-transitory computer-readable medium that comprises the steps of the method described above. The computer program described in FIGS. 3-7 is referred to herein as the Simulation tool. FIGS. 3-7 show a graphical user interface of the simulation software showing the results of the Simulation tool and intermediate steps of the method. The Simulation tool provides a centralized configuration and visualization area for simulating electronic message campaigns. It may include a completely automated and controlled execution of the analysis of a campaign with both proactive and reactive processing. It should be noted that various aspects of the Simulation tool may be manually driven.

The Simulation tool may be based on any development platform, such as the Node.js platform. While the Node.js platform may be used, any other number of development platforms may also be used. As noted above, the Simulation tool utilizes a database of simulated subscribers to provide a user with information for maximizing electronic message campaigns. In particular, based upon this information, the user can adjust the campaign to attempt to improve the efficacy of the campaign. The Simulation tool uses visualization techniques to make poor engagement results easy to identify. The Simulation tool generally allows companies to maximize electronic message campaigns prior to sending the electronic messages, evaluate products in a pre-sales setting, and/or perform quality assurance processes on new product features prior to release into a production setting, among other uses.

FIG. 3 shows a graphical user interface 300 of the Simulation tool showing a schedule for various types of message campaigns to be triggered in the Simulation tool. As shown in FIG. 3, the Simulation tool may be used in connection with a marketing campaign to simulate how the marketing campaign may perform with real subscribers. In this example, the marketing campaign identifies various communication to send throughout the month of August to subscribers, each communication possibly having a separate content and directed to separate subscribers. As shown in this example, the marketing campaign may send communications through various communication channels: email, mobile, Facebook, and others.

When using the Simulation tool, the marketing campaign may be executed in a similar manner as it would be executed against real subscribers. For example, when the marketing campaign sends an email to virtual subscribers through the Welcome Program, each email is received by the Simulation tool for each virtual subscriber and processed according to the virtual subscriber's expected engagement information. In another example, when the marketing campaign is directed to send SMS messages to virtual subscriber's mobile devices, the Simulation tool captures the SMS messages being sent and processes them through a server according to each virtual subscribers expected engagement information. This processing generates marketing activity that an enterprise may use to determine the types of results that can be expected from executing the marketing campaign against real subscribers.

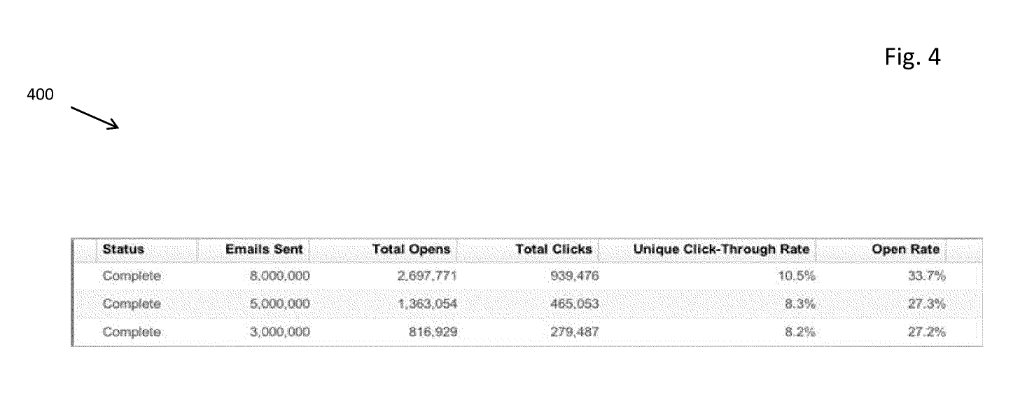

FIGS. 4-7 show examples of graphical user interfaces displaying how the engagement information determined with the Simulation tool may be presented to a user.

In particular, FIG. 4 shows a chart 400 of opens, clicks, click-through rate, and open rate for three different campaigns. In at least one embodiment of the present disclosure, the Simulation tool may generate activity for virtual subscribers upon each communication sent through a simulated marketing campaign. An example generation of communication activity is shown for a campaign in which emails were sent to virtual subscribers. In this example, the chart 400 displays that in a campaign where eight million emails were sent, the virtual subscribers opened 33.7% of the emails sent to the virtual subscribers and clicked 10.5% of links within such emails. In another example for a separate campaign with five million emails, 27.3% of such emails were opened by the virtual subscribers with a 8.3% click rate.

It should be appreciated that the activity generated by the virtual subscribers shown in FIG. 4 may have been generated based on subscriber types. For example, if a percentage of the emails were sent to virtual subscribers associated with a subscriber type indicating that the virtual subscribers are not engaged, the activity generated by these virtual subscribers may result in a low open rate and click through rate. If a percentage of the emails were sent to virtual subscribers associated with a subscriber type indicating that the virtual subscribers are highly engaged, then the resulting customer activity may result in high open rates and high click rates.

It should be appreciated that the systems and methods disclosed herein may generate multiple subscriber types for various virtual subscribers to generate different activity associated with campaigns. This dynamic approach provides a benefit by enabling an enterprise to customize its set of virtual subscribers in an attempt to mirror activity that would be generated if the same campaign were sent to real subscribers.

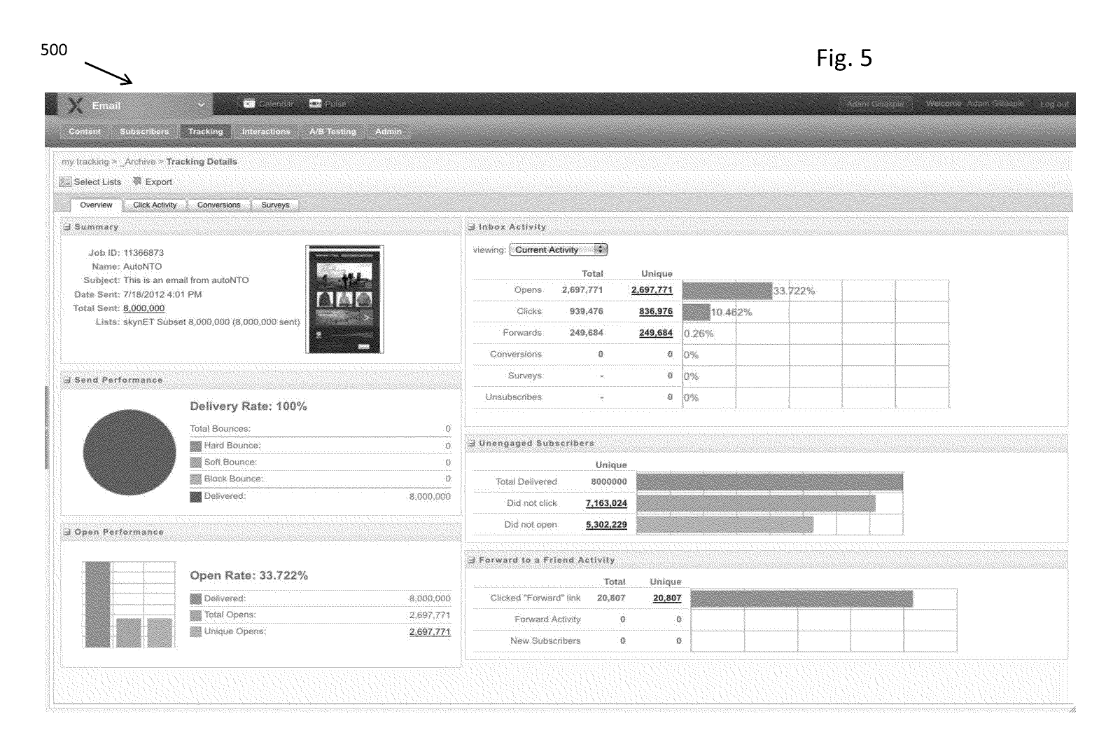

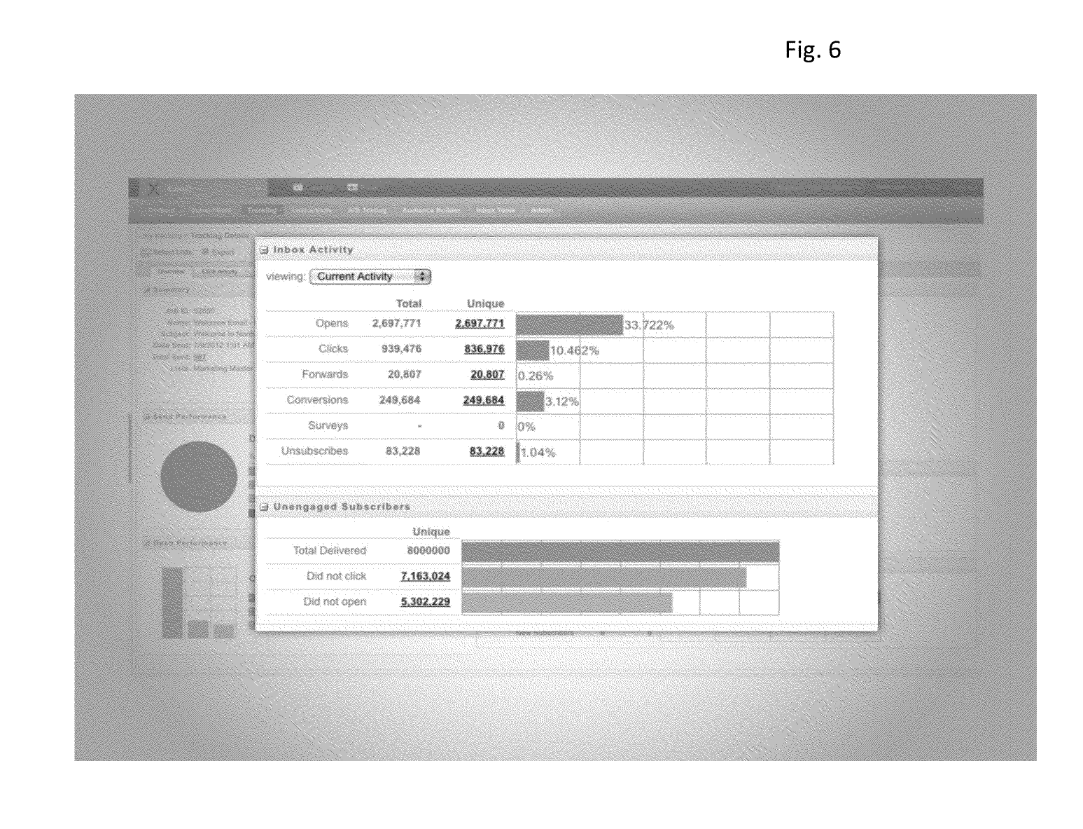

FIG. 5 provides an example of a chart 500 of activity generated by virtual subscribers through execution of the methods and systems disclosed herein. As shown in the example chart 500 of FIG. 5, a campaign sent eight million communications to unengaged subscribers and received activity generated by such subscribers opening communications, clicking links within communications, and forwarding communications to other recipients. In this example, the chart 500 displays activity generated by virtual subscribers created through execution of the systems and methods herein. It should be appreciated that the virtual subscribers generate activity that attempts to mirror activity generated by real subscribers. FIG. 6, for example, shows a more detailed breakdown of engagement activity relative to a particular campaign.

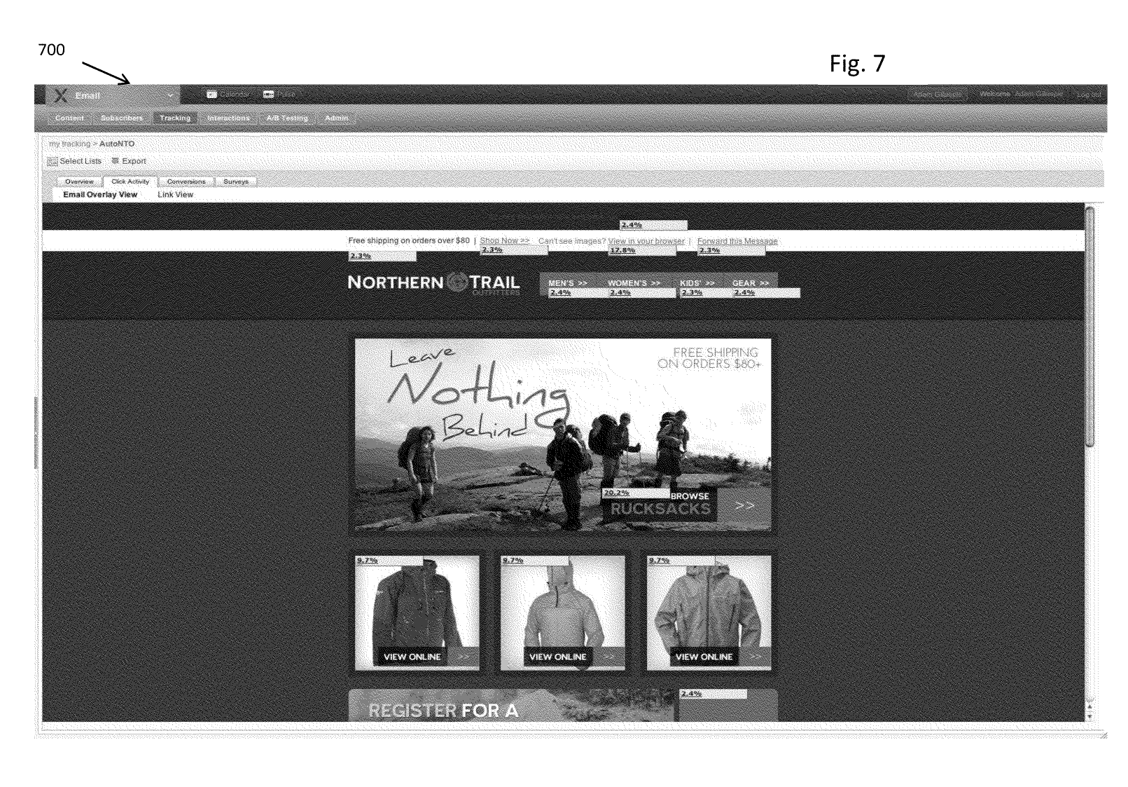

In another example, FIG. 7 shows an email 700 sent to virtual subscribers with click rate percentages received as activity for each area of the email that may be interacted with by a subscriber. As shown in this example, the virtual subscribers generated activity to interact with different parts of the email with different rates. As described above, each virtual subscriber may be configured with a percent chance of interaction to communications and components within communications. As shown in the email 700, for example, the virtual subscribers clicked the “BROWSE RUCKSACKS” link at a rate of 20.2% whereas other links were virtually clicked by these subscribers less frequently.

It should be noted that the method, system, and non-transitory computer-readable medium for simulating an electronic message campaign of the present disclosure may be used along with or to complement one or more programs.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

What is claimed is:

1. A computerized method for simulating an electronic message campaign comprising:
defining one or more simulated subscribers, each simulated subscriber having a subscriber type;
storing an information item associated with each subscriber in a database, wherein the information comprises profile information and the subscriber type of the simulated subscriber;
receiving one or more communications addressed to the one or more simulated subscribers; and
generating analytics for each communication by processing the one or more communications for the one or more subscribers based upon the profile information and the subscriber type.

2. The method of claim 1, wherein the subscriber type includes expected engagement information.

3. The method of claim 1, further comprising associating a demographic information with each subscriber based at least in part on the subscriber type.

4. The method of claim 1, further comprising sending the one or more communications to the one or more simulated subscribers.

5. The method of claim 4, wherein the one or more communications comprises one or more emails.

6. The method of claim 1, wherein the receiving step comprises inserting the one or more communications into a virtual mailbox associated with each subscriber, the virtual mailbox being stored within in the database.

7. The method of claim 6, wherein the generating step comprises retrieving each of the one or more communications from the virtual mailbox and processing each of the one or more communications based on the subscriber type of the simulated subscriber.

8. The method of claim 1, wherein the campaign activity includes at least one of downloading a web beacon, clicking a link, and performing a conversion.

9. The method of claim 1, wherein the profile information includes a demographic information.

10. The method of claim 1, wherein the one or more communications comprise one or more SMS messages.

11. The method of claim 1, wherein the one or more communications comprise one or more social media messages.

12. A system for simulating an electronic message campaign comprising:
a first remote device;
a database comprising a profile for each of one or more simulated subscribers, wherein each profile includes expected engagement information; and
a host server operably connected to the first remote device and the database,
wherein the host server is configured to:
receive one or more communications from the first remote device addressed to the one or more simulated subscribers; and
process the one or more communications based upon the profile of each of the one or more simulated subscribers, wherein processing the one or more communications comprises generating a customer activity for each of the one or more simulated subscribers based at least in part on the profile.

13. The system of claim 12, wherein the first remote device and the host server are the same.

14. The system of claim 12, wherein the host server is further configured to insert the campaign activity into the database.

15. The system of claim 12, wherein each profile further includes a demographic information.

16. The system of claim 12, wherein the host server, first remote device, and database are connected through a computer network.

17. The system of claim 12, wherein the one or more communications are social media messages and the host server is further configured to store the social media messages in the database.

18. A computerized method for simulating an electronic message campaign, the method comprising:
defining a plurality of subscriber types in a database, each subscriber type having a demographic information and an expected engagement information; and
associating one subscriber type of the plurality of subscriber types to each virtual subscriber of a plurality of virtual subscribers stored in the database;
receiving a plurality of communications, each of the plurality of communications being addressed to one virtual subscriber of the plurality of virtual subscribers; and
generating an analytics information item from the plurality of communications based at least in part on the subscriber type associated with each virtual subscriber.

19. The method of claim 18, wherein the expected engagement information comprises a likelihood of opening a communication.

20. The method of claim 18, wherein the expected engagement information comprises a likelihood of visiting a hyperlink within a communication.
